(19) United States
(12) Patent Application Publication
(10) Pub. No.: US 2005/0013402 A1
(43) Pub. Date: Jan. 20, 2005

(54) Method of operating a nuclear power plant

(76) Inventor: Willem Adriaan Odendaal Kriel, Centurion (ZA)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/492,265

(22) PCT Filed: Oct. 10, 2002
(86) PCT No.: PCT/IB02/04161

(30) Foreign Application Priority Data
Oct. 11, 2001 (ZA) 01/8370

(51) Int. Cl. G21C 3/56; G21D 3/14

(52) U.S. Cl. 376/383

(57) ABSTRACT

This invention relates to a method of operating a nuclear power plant (10) when power demand from an electrical distribution grid, to which the power plant (10) is connected and with which the power plant (10) is synchronised, decreases to zero. The method includes reducing electrical power generated by the plant (10) to house load, and changing the plant (10) from a power operation mode, in which the Brayton cycle is self-sustaining, to a standby mode, in which the Brayton cycle is not self-sustaining and mass flow of working fluid around the power generation circuit (12) is achieved by an auxiliary blower system (38) and in which the plant (10) remains synchronised with the grid.

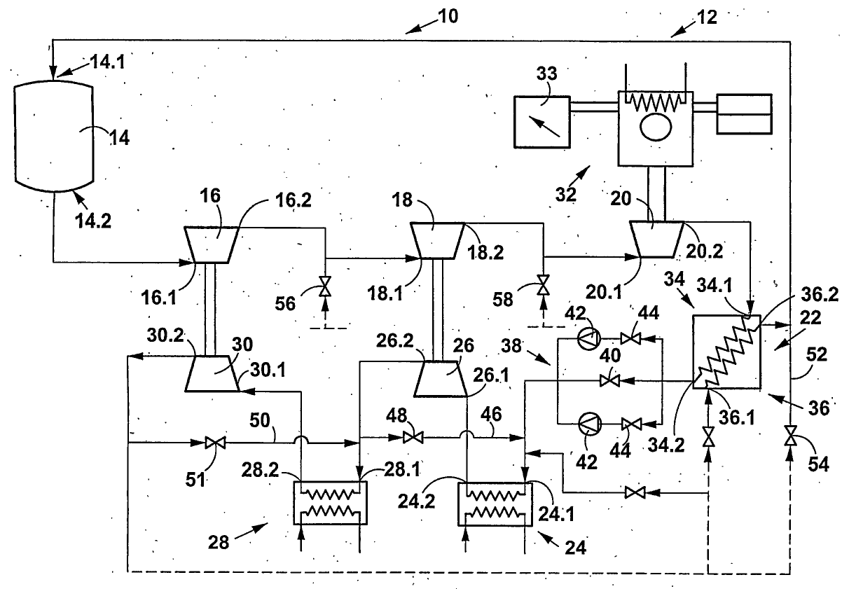

THIS INVENTION relates to a nuclear power plant. More particularly it relates to a method of operating the nuclear power plant when power demand decreases to zero.

The Inventor is aware of a nuclear power plant which includes a closed loop power generation circuit configured to make use of a Brayton cycle as the thermodynamic conversion cycle.

The nuclear power plant is typically connected to a national grid and electricity generated by the plant must vary to correspond to the demand from the grid.

The possibility exists that the national control centre requires minimal delivery of electricity to the grid. In this situation, i.e. when power demand from the grid decreases to zero, the plant will generate house loads with no or minimal power delivery to the grid.

It is also important that the plant remain synchronised with the grid so as to be able to satisfy a demand for power increase relatively quickly and, to this end, that the reactor remain critical.

Further, it is desirable, in the interests of efficiency, to reduce fuel consumption when power delivery to the grid is zero. In the context of this specification it is to be understood that zero power delivery to the grid is intended to include both the situation when no power is delivered to the grid and that when power delivery to the grid is at a very low level.

According to the invention, there is provided a method of operating a nuclear power plant, which is connected to and synchronised with an electrical distribution grid and which has a closed loop power generation circuit making use of helium as the working fluid and a Brayton cycle as the thermodynamic conversion cycle, when power demand from the grid decreases to zero, which method includes the steps of
reducing electrical power generated by the plant to house load; and
changing the plant from a power operation mode, in which the Brayton cycle is self-sustaining, to a standby mode, in which the Brayton cycle is not self-sustaining and mass flow of working fluid around the power generation circuit is achieved by an auxiliary blower system and in which the plant remains synchronised with the grid.

Were it not for the auxiliary blower system sustaining or supporting the working fluid mass flow, the mass flow would diminish to an undesirable state.

When the power generation circuit includes a reactor, a high pressure turbine and low pressure turbine, which are drivingly connected, respectively, to a high pressure compressor and a low pressure compressor, a power turbine drivingly connected to a generator, a high pressure compressor recirculation line, in which is mounted a high pressure compressor recirculation valve, and a low pressure compressor recirculation line, in which is mounted a low pressure compressor recirculation valve, reducing the electrical power generated may include opening one or both of the compressor recirculation valves. The method may further include controlling the positions of the compressor recirculation valves so that the generator produces house load for the plant and the power to the electrical distribution grid is zero.

Reducing the electrical power generated may include reducing the inventory of helium in the power generation circuit.

The nuclear power plant may include a helium inventory control system (HICS) which can be used to increase or decrease the helium inventory in the power generation circuit. Accordingly, reducing the helium inventory in the power generation circuit may include connecting a helium inventory control system in flow communication with the power generation circuit and permitting the transfer of helium from the power generation circuit to the helium inventory control system, thereby to generate less power.

During this process, the mass flow through the core decreases, which results in a decrease in nuclear power generated. However, because the efficiency of the Brayton cycle is very low at low mass flows, the nuclear power generated in the core is still significant. A large part of the energy created in the core is dumped into heat exchangers. The compressor recirculation lines create “internal circujts” with either a high mass flow or a relatively high temperature. These two circuits create the condition that the heat can be removed from the system and dumped into the heat exchanger. Only a small part of the energy generated in the core is used to produce the necessary house load.

This situation may last for a relatively long time, typically of the order of eight hours, e.g. during the night. This means that despite the fact that no power is delivered to the grid, the consumption of nuclear fuel is still significant.

Changing the plant from a power operation mode to a standby mode may include, after the plant has stabilised, creating a transition situation where mass flow in the power generation circuit is created by the auxiliary blower system while the power turbine still generates the house load.

When the auxiliary blower system includes a normally open blower system in-line valve, a pair of blowers connected in parallel therewith, and a normally closed blower isolation valve connected in series with each of the blowers, creating the transition situation may include starting the blowers and controlling the positions of the compressor recirculation valves, blower system in-line valve and blower isolation valves. The auxiliary blower system may also function as a start-up blower system for use as plant start-up.

After a successful transition, the high pressure and the low pressure turbine/compressors are operating at significantly reduced mass flow rates, which means low efficiency levels, and significantly less energy is dumped into the heat exchanger. The average core temperature increases and the nuclear power generated in the core decreases. This means that significantly less nuclear fuel is consumed in this standby mode than would be consumed in a low power operation mode. The advantage of operating the plant in this state is that minimal electric power is generated and that the plant remains connected electrically to the grid. The plant is still synchronized to the grid. As a result, the plant can quickly return to a condition of significant electrical power production by closing the recirculation valves and switching off the auxiliary blower system.

With the plant in standby mode it is ready to make the transition to power operation mode. However, the time consuming synchroniation is not necessary thereby permitting the plant to react to an increase in power demand relatively quickly since the reactor remains critical. The power turbine stays synchronised at 50 Hz, and thus no unnecessary cycling between 0 Hz and 60 Hz is required.

The invention will now be described, by way of example, with reference to the accompanying diagrammatic drawing which shows a schematic representation of a nuclear power plant in accordance with the invention.

In the drawing, reference numeral 10 refers generally to part of a nuclear power plant in accordance with the invention.

The nuclear power plant 10 includes a closed loop power generation circuit, generally indicated by reference numeral 12, which makes use of helium as the working fluid. The power generation circuit 12 includes a nuclear reactor 14, a high pressure turbine 16, a low pressure turbine 18, a power turbine 20, a recuperator 22, a pre-cooler 24, a low pressure compressor 26, an inter-cooler 28 and a high pressure compressor 30.

The reactor 14 is a pebble bed reactor making use of spherical fuel elements. The reactor 14 has an inlet 14.1 and an outlet 14.2.

The high pressure turbine 16 is drivingly connected to the high pressure compressor 30 and has an upstream side or inlet 16.1 and a downstream side or outlet 16.2, the inlet 16.1 being connected to the outlet 14.2 of the reactor 14.

The low pressure turbine 18 is drivingly connected to the low pressure compressor 26 and has an upstream side or inlet 18.1 and a downstream side or outlet 18.2. The inlet 18.1 is connected to the outlet 16.2 of the high pressure turbine 16.

The nuclear power plant 10 includes a generator, generally indicated by reference numeral 32 to which the power turbine 20 is drivingly connected. The power turbine 20 includes an upstream side or inlet 20.1 and a downstream side or outlet 20.2. The inlet 20.1 of the power turbine 20 is connected to the outlet 18.2 of the low pressure turbine 18.

A variable resistor bank 33 is disconnectably connectable to the generator 32.

The recuperator 22 has a hot or low pressure side 34 and a cold or high pressure side 36. The low pressure side of the recuperator 34 has an inlet 34.1 and an outlet 34.2. The inlet 34.1 of the low pressure side is connected to the outlet 20.2 of the power turbine 20.

The pre-cooler 24 is a helium to water heat exchanger and includes a helium inlet 24.1 and a helium outlet 24.2. The inlet 24.1 of the pre-cooler 24 is connected to the outlet 34.2 of the low pressure side 34 of the recuperator 22.

The low pressure compressor 26 has an upstream side or inlet 26.1 and a downstream side or outlet 26.2. The inlet 26.1 of the low pressure compressor 26 is connected to the helium outlet 24.2 of the pre-cooler 24.

The inter-cooler 28 is a helium to water heat exchanger and includes a helium inlet 28.1 and a helium outlet 28.2. The helium inlet 28.1 is connected to the outlet 26.2 of the low pressure compressor 26.

The high pressure compressor 30 includes an upstream side or inlet 30.1 and a downstream side or outlet 30.2. The inlet 30.1 of the high pressure compressor 30 is connected to the helium outlet 28.2 of the inter-cooler 28. The outlet 30.2 of the high pressure compressor 30 is connected to an inlet 36.1 of the high pressure side 36 of the recuperator 22. An outlet 36.2 of the high pressure side 36 of the recuperator 22 is connected to the inlet 14.1 of the reactor 14.

The nuclear power plant 10 includes an auxiliary or start-up blower system, generally indicated by reference numeral 38, connected between the outlet 34.2 of the low pressure side 34 of the recuperator 22 and the inlet 24.1 of the pre-cooler 24.

The auxiliary blower system 38 includes a normally open start-up blower system in-line valve 40, which is connected in-line between the outlet 34.2 of the low pressure side 34 of the recuperator 22 and the inlet 24.1 of the pre-cooler 24. Two blowers 42 are connected in parallel with the start-up blower system in-line valve 40 and a normally closed isolation valve 44 is associated with and connected in series with each blower 42.

A low pressure compressor recirculation line 46 extends from a position between the outlet or downstream side 26.2 of the low pressure compressor 26 and the inlet 28.1 of the inter-cooler 28 to a position between the auxiliary blower system 38 and the inlet 24.1 of the pre-cooler 24. A normally closed low pressure recirculation valve 48 is mounted in the low pressure compressor recirculation line 46.

A high pressure compressor recirculation line 50 extends from a position between the outlet or downstream side 30.2 of the high pressure compressor 30 and the inlet 36.1 of the high pressure side 36 of the recuperator 22 to a position between the outlet or downstream side 26.2 of the low pressure compressor 26 and the inlet 28.1 of the inter-cooler 28. A normally closed high pressure recirculation valve 51 is mounted in the high pressure compressor recirculation line 50.

A recuperator recirculation line 52 extends from a position upstream of the inlet 36.1 of the high pressure side 36 of the recuperator 22 to a position downstream of the outlet 36.2 of the high pressure side 36 of the recuperator 22. A normally closed recuperator recirculation valve 54 is mounted in the recuperator recirculation line 52.

The plant 10 includes a high pressure coolant valve 56 and a low pressure coolant valve 58. The high pressure coolant valve 56 is configured, when open, to provide a recirculation of helium from the high pressure side or outlet 30.2 of the high pressure compressor 30 to the inlet or low pressure side 18.1 of the low pressure turbine 18. The low pressure coolant valve 58 is configured, when open, to provide a recirculation of helium from the high pressure side or outlet 30.2 of the high pressure compressor 30 to the inlet 20.1 of the power turbine 20.

In use, the plant 10 is connected to a national electrical distribution grid (not shown) and the power supplied to the grid from the plant is determined by a national control centre. Accordingly, the power generated by the plant varies according to the demand received from the national control centre.

In use, under normal demand conditions, the power generation circuit 12 operates on a self-sustaining Brayton cycle.

However, when the national control centre requires no or minimal delivery to the grid, the power generated by the plant is reduced to house load.

This can be achieved whilst maintaining the Brayton cycle, however, this leads to excessive fuel consumption and is undesirable. Accordingly, in this situation, the electrical power generated by the plant is reduced to house loads and the plant is then changed from a power operation mode, in which the Brayton cycle is self-sustaining, to a standby mode, in which the Brayton cycle is not self-sustaining and mass flow of working fluid around the power generation circuit is achieved by the auxiliary blower system.

Accordingly, when a signal is received to reduce the power generated to house loads, the mass flow through the core of the reactor 14 is reduced. This is achieved by reducing the helium inventory in the power generation circuit 12 and also by opening one or both of the compressor recirculation valves 48, 51. During this process, the mass flow through the core 14 decreases. This results in an increase in the average core temperature. The resulting negative reactivity feedback from the core results in a decrease in nuclear power generated in the core 14. However, because the efficiency of the Brayton cycle is very low at low mass flows due to the use of the compressor recirculation valves 48, 51, the nuclear power generated in the core is still significant, typically of the order of 40 to 80 MW. A large part of the energy generated in the core 14 is dumped into the inter-cooler 28 and the pre-cooler 24. In addition, as a result of the helium circulating around the compressors 26, 30, circuits are created with either a high mass flow or a relatively high temperature. Once the plant is stable, a transition situation is then created where mass flow in the power generation circuit 12 is created by the auxiliary blower system 38. To this end, the positions of the compressor recirculation valves 48, 51, blower system in-line valve 40 and blower isolation valves 44 are controlled and at some stage the Brayton cycle will cease to be self-sustaining and mass flow in the power generation circuit 12 will be achieved by means of the blower system 38.

After a successful transition, the high pressure and low pressure turbine/compressors 16, 30/18, 26 are operating at significantly reduced mass flow rates, which means low efficiency levels and significantly less energy is dumped into the heat exchangers 24, 28. The average core temperature increases and the nuclear power generated in the core decreases to less than 20 MW. This means that significantly less nuclear fuel is consumed in the standby mode and the reactor remains critical.

When the power demand Increases, the Brayton cycle can be restarted by returning the plant 10 to a power operation mode. In view of the fact that the generator 32 has remained synchronized with the grid and the reactor 14 has remained critical, the time consuming synchronization is not necessary thereby permitting the plant 10 to react to an increase in power demand relatively quickly.

The Inventor believes that by operating the nuclear power plant 10 in the manner described above, consumption of nuclear fuel can be reduced substantially with corresponding increases in efficiency.

1. A method of operating a nuclear power plant, which is connected to and synchronised with an electrical distribution grid and which has a closed loop power generation circuit, including a reactor, a high pressure compressor, and a power turbine drivingly conncected to a generator, the power generation circuit making use of helium as the working fluid and a Brayton cycle as the thermodynamic conversion cycle, when power demand from the grid decreases to zero, which method includes the steps of
reducing electrical power generated by the plant to house load; and
changing the plant from a power operation mode to a standby mode, in which mass flow of working fluid around the power generation circuit is achieved by an auxiliary blower system, which includes a normally open blower system in-line valve mounted in the power generation circuit, at least one blower connected in parallel therewith, and a normally closed blower isolation valve connected in series with the at least one blower, and in which the plant remains synchronised with the grid.

2. A method as claimed in claim 1, in which, when the power generation circuit includes a high pressure turbine and low pressure turbine, which are drivingly connected, respectively, to a high pressure compressor and a low pressure compressor, a high pressure compressor recirculation line, in which is mounted a high pressure compressor recirculation valve, and a low pressure compressor recirculation line, in which is mounted a low pressure compressor recirculation valve, reducing the electrical power generated includes opening one or both of the compressor recirculation valves.

3. A method as claimed in claim 2, which further includes controlling the positions of the compressor recirculation valves so that the generator produces house load for the plant and the power to the electrical distribution grid is zero.

4. A method as claimed in claim 2 in which reducing the electrical power generated includes reducing the inventory of helium in the power generation circuit.

5. A method as claimed in claim 4, in which reducing the helium inventory in the power generation circuit includes connecting a helium inventory control system in flow communication with the power generation circuit and permitting the transfer of helium from the power generation circuit to the helium inventory control system.

6. A method as claimed in claim 3 in which changing the plant from a power operation mode to a standby mode includes, after the plant has stabilised, creating a transition situation where mass flow in the power generation circuit is created by the auxiliary blower system while the power turbine still generates the house load.

7. A method as claimed in claim 6, in which, when the auxiliary blower system includes a pair of blowers connected in parallel with the normally open blower system in-line valve, and a normally closed blower isolation valve connected in series with each of the blowers, creating the transition situation includes starting the blowers and controlling the positions of the compressor recirculation valves, blower system in-line valve and the blower isolation valves.

8-9. (canceled)
